(19) United States
(12) Patent Application Publication
(10) Pub. No.: US 2013/0198297 A1
(43) Pub. Date: Aug. 1, 2013

(54) Processing Data Relating To A Communication Event

(71) Applicants: Ando Saabas, Tallinn (EE); André Karpistsenko, Tallinn (EE); Sören Vang Andersen, Esch-Sur-Alzette (LU); Teele Tamme, Tallinn (EE); Markus Vaalgamaa, Helsinki (FI); André Veski, Tallinn (EE)

(72) Inventors: Ando Saabas, Tallinn (EE); André Karpistsenko, Tallinn (EE); Sören Vang Andersen, Esch-Sur-Alzette (LU); Teele Tamme, Tallinn (EE); Markus Vaalgamaa, Helsinki (FI); André Veski, Tallinn (EE)

(21) Appl. No.: 13/408,362

(22) Filed: Feb. 29, 2012

(30) Foreign Application Priority Data
Jan. 26, 2012 (GB) 1201300.9

(51) Int. Cl. G06F 15/16

(52) U.S. Cl. 709/206; 709/204

(57) ABSTRACT

Method, user terminal and computer program product for processing data relating to a communication event at a communication client, the communication event occurring over a communication system. An input of the communication event is received at the communication client from a user of the communication system. The input is analyzed to determine attributes of the input. At least one other user of the communication system who is likely to be a participant of the communication event is determined based on the occurrence of attributes, corresponding to the determined attributes of the input, in previous communication events over the communication system involving at least one of the at least one other user. The communication client indicates, to the user, the determined at least one other user as being a likely participant for the communication event.

### RELATED APPLICATION

This application claims priority under 35 U.S.C. §119 or 365 to Great Britain Application No. GB 1201300.9, filed Jan. 26, 2012. The entire teachings of the above application are incorporated herein by reference.

### TECHNICAL FIELD

The present invention relates to processing data relating to a communication event.

### BACKGROUND

Communication events can be implemented between users of a communication system to thereby allow the users to communicate with each other. A communication event may be a call (e.g. a video or audio call), an instant messaging session, an email or other suitable event by which users can transfer data between each other over the communication system. Each user may use a communication client executed at a user terminal in order to login to the communication system and in order to engage in communication events over the communication system. A communication event may involve two users of the communication system. Furthermore, a communication event may be a group communication event involving more than two users of the communication system. For example, an email may be sent from a sender to more than one recipient, or a group call or a group instant messaging session may have more than two participants.

When a group communication event is initiated, or when users are being added to a group communication event, a communication client may allow a user to add participants to the group communication event (e.g. by adding recipients to an email message). A first method is for the user to manually select contacts (that is, manually select other users of the communication system with whom the user has an association) directly from an address book, wherein the selected contacts are included as participants in the group communication event. A second method is by using a so-called “quick filter”, whereby the user starts typing a contact name into a designated filter box, and the user interface (UI) of the client presents the contacts whose names partially match the string already entered in the filter box. For example, the client would present the contacts “Andrew”, “Ann” and “Anthony” when the user enters “An” into the filter box.

These methods may be satisfactory when trying to find one or a few contacts but become tedious and time consuming when the number of contacts becomes large (e.g. when the number of contacts reaches the hundreds). There are two main problems with the prior art approaches to adding participants to a group communication event (e.g. adding recipients to an email or participants to a group call or a group instant messaging session), and they are:
1) manually adding a large number of contacts (such as ten or more contacts) is a laborious process which may be time-consuming and boring to a user, and
2) it is very easy for the user to miss a contact that was intended to be a participant of the group communication event.

One approach to addressing these problems in an email system is to create manually managed groups of users for reducing e-mail creation overhead. For example, there may be a group of users called “family” which a user can manually populate such that when sending an email to all of his family he can select the group rather than having to select each member of his family from the contact list separately. The user may have a similar group called “work colleagues” which the user can manually populate to include his work colleagues. The user may create other similar groups. This approach requires time to be spent by the user to manually manage the groups, and the approach is inflexible in that the user can only use the approach to send emails to specific, already-created groups.

### SUMMARY

According to a first aspect of the invention there is provided a method of processing data relating to a communication event at a communication client, said communication event occurring over a communication system, the method comprising: receiving, at the communication client from a user of the communication system, an input of the communication event; analysing the input to determine attributes of the input; determining at least one other user of the communication system who is likely to be a participant of the communication event based on the occurrence of attributes, corresponding to the determined attributes of the input, in previous communication events over the communication system involving at least one of said at least one other user; and the communication client indicating, to said user, said determined at least one other user as being a likely participant for the communication event.

Advantageously, attributes of previous communication events are used to determine, and indicate to the user, one or more other users of the communication system who are likely to be participants of a communication event for which the user has provided an input.

For example, the user may input a particular participant of the communication event (e.g. the user may input a recipient of an email message, or may specify a participant of a group instant messaging session or group call). The communication client may then determine, based on previous communication events, that when the particular participant is a participant of a communication event then a further user is often also a participant of the communication event. This is then indicated to the user to thereby make it simpler for the user to add the further user to the communication event. As another example, the user may input some particular text (e.g. a keyword) for the communication event (e.g. a subject field for an email message or some text for the body of an email message or for an instant message). The communication client may then determine, based on previous communication events, that when that particular keyword is included in a communication event then a particular further user is often a participant of the communication event. This is then indicated to the user to thereby make it simpler for the user to add the particular further user to the communication event.

Embodiments therefore provide for a simple process for the user to add participants to a communication event based on previous communication events. The process may involve fewer UI manipulations (e.g. clicks and/or keystrokes) than the prior art methods of adding participants to a communication event. Furthermore, the likelihood of a user error such as missing contacts that were intended to be among the participants of the communication event is reduced. An overall benefit is a smoother and more convenient user experience of adding one or more participants to a communication event.

The user may select a user from the indicated at least one other user, and the method may further comprise adding the selected user as a participant of the communication event.

The indicating of the at least one other user may comprise displaying said at least one other user in a list which is ordered according to the likelihood of the at least one other user being a participant of the communication event. The user may select a user from the list to include as a participant of the communication event.

The attributes may comprise an indication of a participant of the communication event. The attributes may comprise information, such as a keyword, to be communicated in the communication event to participants of the communication event.

The communication event may include transmitting a message over the communication system and the keyword may be included in a subject field or a body of the message.

The method may further comprise generating relevancy information for said at least one other user from said previous communication events, the relevancy information providing indications as to the relevancy of said at least one other user to said attributes in the previous communication events, wherein the relevancy information may be used in said step of determining at least one other user of the communication system who is likely to be a participant of the communication event. The method may further comprise updating and storing the relevancy information for each communication event involving the user. The relevancy information may comprise a respective user relevancy weight for each user-user pair in the communication system, wherein each user relevancy weight indicates the likelihood that a communication event has both of the users of the respective user-user pair as participants, given that one of the users of the respective user-user pair is a participant. The user relevancy weights may be determined based on the participants of previous communication events for which said user is a participant.

The method may further comprise, for each communication event for which said user and the users of a particular user-user pair are participants, increasing the respective user relevancy weight for the particular user-user pair. The method may further comprise applying a reduction to the user relevancy weights over time.

The relevancy information may comprise a respective keyword relevancy weight for each keyword-user pair, wherein each keyword relevancy weight indicates the likelihood that a communication event has the user of the respective keyword-user pair as a participant, given that the communication event includes the keyword of the respective keyword-user pair. The keyword relevancy weights may be determined based on the participants of previous communication events for which said user is a participant and on the occurrence of the keywords in those previous communication events. The method may further comprise, for each communication event for which said user and the user of a particular keyword-user pair are participants and for which the communication event includes the keyword of the particular keyword-user pair, increasing the respective keyword relevancy weight for the particular keyword-user pair. The method may further comprise applying a reduction to the keyword relevancy weights over time.

The communication event may comprise one of: (i) sending an email, (ii) a call, and (iii) an instant messaging session. A participant of the communication event may be either: (i) a recipient of the communication event, wherein the communication event is initiated by the user; or (ii) a participant of a group communication event in which the user is a participant.

The input may be for initiating the communication event. Alternatively, the input may be for adding a participant to an already established communication event.

The method may be performed by the communication client at a user terminal of the user.

According to a second aspect of the invention there is provided a user terminal configured to execute a communication client for processing data relating to a communication event occurring over a communication system, the communication client being configured to: receive, from a user of the communication system, an input of the communication event; analyse the input to determine attributes of the input; determine at least one other user of the communication system who is likely to be a participant of the communication event based on the occurrence of attributes, corresponding to the determined attributes of the input, in previous communication events over the communication system involving at least one of said at least one other user; and indicate, to said user, said determined at least one other user as being a likely participant for the communication event.

According to a third aspect of the invention there is provided a computer program product for implementing a communication client to process data relating to a communication event, the computer program product being embodied on a non-transient computer-readable medium and configured so as when executed on a processor of a user terminal to perform the methods described herein.

### BRIEF DESCRIPTION OF THE DRAWINGS

For a better understanding of the present invention and to show how the same may be put into effect, reference will now be made, by way of example, to the following drawings in which:

FIG. 1 shows a communication system according to a preferred embodiment;

FIG. 2 shows a schematic view of a device according to a preferred embodiment;

FIG. 3 is a flow chart for a process of processing data relating to a communication event according to a preferred embodiment;

FIG. 4a is a representation of a user interface of a client according to a first scenario;

FIG. 4b is a representation of the user interface of the client according to a second scenario; and

FIG. 4c is a representation of the user interface of the client according to a third scenario.

### DETAILED DESCRIPTION

Preferred embodiments of the invention will now be described by way of example only.

The inventors have proposed a way of initiating and/or organizing group communication events (such as group messaging and group multichats) based on contextual information from previous communication events in a communication system. Preferred embodiments simplify chat creation and message sending, by suggesting contacts that should be the recipients of a message or should be included in a group chat. There is a strong community structure present in a user's inbox of email messages or in the user's chat history which can be used to indicate which of the user's contacts in the communication system are most likely to be the recipients of a particular message or the participants of a particular group call or group instant messaging session. This information can be actively used to provide a smoother user experience of initiating and organizing group communication events.

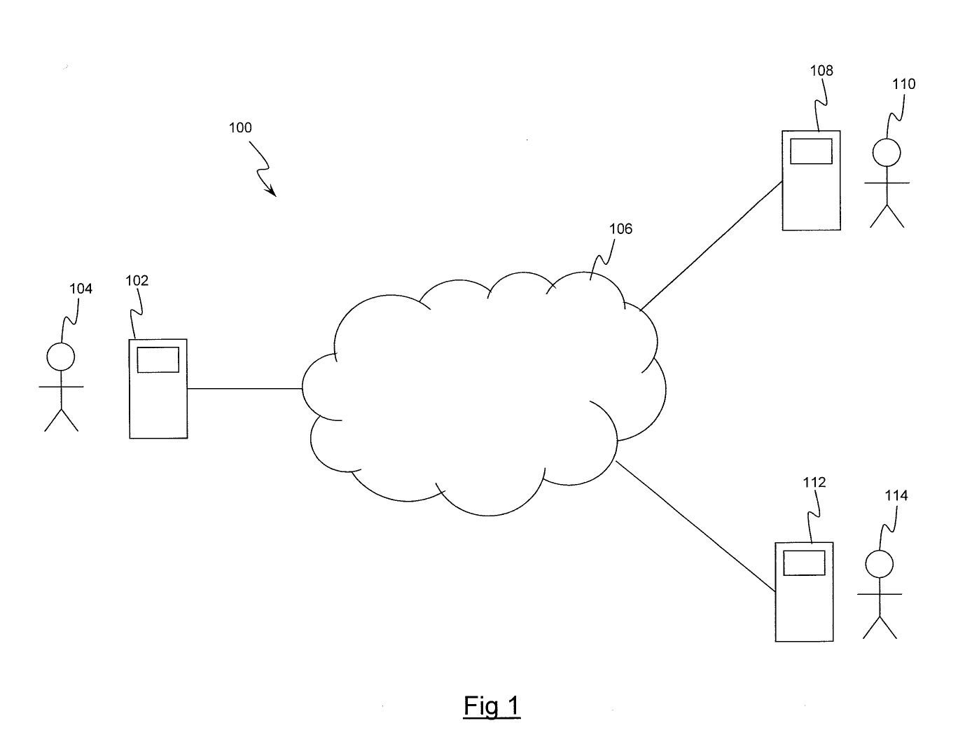

FIG. 1 shows a communication system 100 comprising a first user 104 who is associated with a first user terminal 102, a second user 110 who is associated with a second user terminal 108, and a third user 114 who is associated with a third user terminal 112. In other embodiments the communication system 100 may comprise any number of users and associated user terminals. The user terminals 102, 108 and 112 can communicate over the network 106 in the communication system 100, thereby allowing the users 104, 110 and 114 to communicate with each other over the network 106. In the preferred embodiment the communication system 100 is a packet-based, P2P communication system, but other types of communication system could also be used, such as non-P2P, VoIP or IM systems. The network 106 may, for example, be the Internet or another type of network such as a telephone network (such as the PSTN or a mobile telephone network). The user terminal 102 may be, for example, a mobile phone, a television, a personal digital assistant (“PDA”), a personal computer (“PC”) (including, for example, Windows™, Mac OS™ and Linux™ PCs), a gaming device or other embedded device able to connect to the network 106. The user terminal 102 is arranged to receive information from and output information to the user 104 of the user terminal 102. In a preferred embodiment of the invention the user terminal 102 comprises a display such as a screen and an input device such as a keypad, a touch-screen, and/or a microphone. The user terminal 102 is connected to the network 106.

The user terminal 102 executes a communication client, provided by a software provider associated with the communication system 100. The communication client is a software program executed on a local processor in the user terminal 102. The client performs the processing required at the user terminal 102 in order for the user terminal 102 to transmit and receive data over the communication system 100. As is known in the art, the client executed at the user terminal 102 may be authenticated to communicate over the communication system through the presentation of digital certificates (e.g. to prove that user 104 is a genuine subscriber of the communication system—described in more detail in WO 2005/009019).

The user terminals 108 and 112 may correspond to the user terminal 102. The user terminal 108 executes, on a local processor, a communication client which corresponds to the communication client executed at the user terminal 102. The client at the user terminal 108 performs the processing required to allow the user 110 to communicate over the network 106 in the same way that the client at the user terminal 102 performs the processing required to allow the user 104 to communicate over the network 106. The user terminal 112 executes, on a local processor, a communication client which may correspond to the communication client executed at the user terminal 102. The client at the user terminal 112 performs the processing required to allow the user 114 to communicate over the network 106 in the same way that the client at the user terminal 102 performs the processing required to allow the user 104 to communicate over the network 106. The user terminals 102, 108 and 112 are end points in the communication system. FIG. 1 shows only three users (104, 110 and 114) and three user terminals (102, 108 and 112) for clarity, but many more users and user terminals may be included in the communication system 100, and may communicate over the communication system 100 using respective communication clients executed on the respective user terminals, as is known in the art.

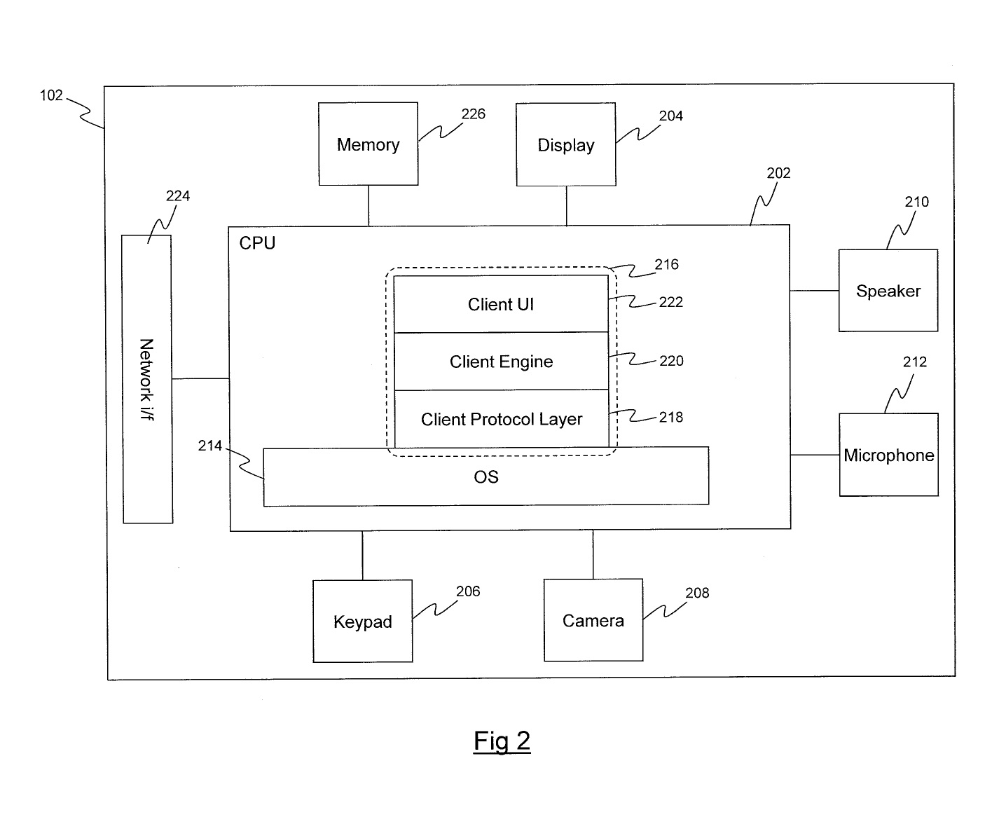

FIG. 2 illustrates a detailed view of the user terminal 102 on which is executed a communication client for communicating over the communication system 100. The user terminal 102 comprises a central processing unit (“CPU”) 202, to which is connected a display 204 such as a screen, input devices such as a keypad 206 and a camera 208. The display 204 may comprise a touch screen for inputting data to the CPU 202. An output audio device 210 (e.g. a speaker) and an input audio device 212 (e.g. a microphone) are connected to the CPU 202. The display 204, keypad 206, camera 208, output audio device 210 and input audio device 212 may be integrated into the user terminal 102 as shown in FIG. 2. In alternative user terminals one or more of the display 204, the keypad 206, the camera 208, the output audio device 210 and the input audio device 212 may not be integrated into the user terminal 104 and may be connected to the CPU 202 via respective interfaces. One example of such an interface is a USB interface. The CPU 202 is connected to a network interface 224 such as a modem for communication with the network 108. The network interface 224 may be integrated into the user terminal 104 as shown in FIG. 2. In alternative user terminals the network interface 224 is not integrated into the user terminal 104. The user terminal 104 also comprises a memory 226 for storing data as is known in the art.

FIG. 2 also illustrates an operating system (“OS”) 214 executed on the CPU 202. Running on top of the OS 214 is a software stack 216 for the client software of the communication system 100. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the network 106 via the network interface 224. The client protocol layer 218 of the client software communicates with the operating system 214 and manages the connections over the communication system. Processes requiring higher level processing are passed to the client engine layer 220. The client engine 220 also communicates with the client user interface layer 222. The client engine 220 may be arranged to control the client user interface layer 222 to present information to the user 104 via the user interface of the client and to receive information from the user 104 via the user interface.

The user terminals 108 and 112 are implemented in the same way as user terminal 102 as described above, wherein the user terminals 108 and 112 may have corresponding elements to those described herein in relation to user terminal 102.

According to embodiments of the invention, when the user 104 provides an input, to the client implemented at the user terminal 102, relating to a communication event, the client can indicate to the user 104 other users of the communication system (e.g. users 110 and 114) which are likely to be recipients of the communication event based on the input provided by the user 104 and based on previous communication events. In order to implement this, preferred embodiments consist of two parts: (i) the computation of relevancy information (sometimes referred to herein as a “relevancy graph”) for users of the communication system, the relevancy information providing indications as to the likelihood of a particular user being a participant in a communication event having particular attributes (e.g. having particular other participants or having particular keywords present in messages of the communication event); and (ii) using the relevancy information for making suggestions of likely participants for a communication event to the user 104 in the UI of the client at the user terminal 102.

The computation of the relevancy information consists of two distinct parts in a preferred implementation. Firstly, the relevancy of contacts with respect to each other is computed and secondly, the relevancy of keywords or topics with respect to each contact is computed. These two parts of the relevancy information are described in more detail below.

Contact link ranking is used to determine the relevancy of contacts with respect to each other. The contacts of the user 104 are other users in the communication system (e.g. users 110 and 114). In this way a user relevancy weight (or score) is determined for each user-user pair. A user relevancy weight for a particular user-user pair, e.g. for the pair of users 110 and 114, provides an indication as to the likelihood that a communication event has both of the users (e.g. users 110 and 114) as participants, given that one of the users of the user-user pair is a participant of the communication event. For example, if the user 104 has included the user 110 in a communication event, the user relevancy weight for the pair of users 110 and 114 would provide an indication as to the likelihood that user 114 should also be a participant of the communication event. The user relevancy weights are based on previous communication events. The previous communication events may include, for example, email messages stored in an inbox of the user 104 or an instant messaging chat history of the user 104.

The relevancy of users (or “contacts”) with respect to each other is computed by the following iterative algorithm. Initially, the user relevancy weight for each user-user pair is set to be zero. Then, each communication event over the communication system in which the user 104 is involved (e.g. for each email message, call or instant messaging chat involving the user 104) is processed and the user relevancy weights for pairs of users who are participants in each communication event are increased. For example the user relevancy weights may be incremented or multiplied by some factor greater than one (or divided by a factor less than one) such that they are increased. There can be multiple recipients of a message and multiple participants of a group call or a group instant messaging chat. For example, if the user 104 receives an email message, which is stored to his inbox, and which includes the users 110 and 114 as participants of the email message (e.g. as either sender or recipient of the email message) then the user relevancy weight for the user-user pair including the users 110 and 114 will be increased. In this way, the user relevancy weights will be higher for user-user pairs which are commonly involved in the same communication events than for user-user pairs which are less commonly involved in the same communication events.

The user relevancy weights decay over time. In order to achieve this, a reduction is applied to the user relevancy weights over time. For example, the reduction may be applied by subtracting a value from the user relevancy weights or by dividing the user relevancy weights by a factor greater than one (or by multiplying the user relevancy weights by a factor less than one). In this way, old connections between users of the communication system become less relevant compared to newer connections.

The user relevancy weights provide an indication as to the structure of the communication system in the sense of which users are likely to be involved in the same communication events. In other words, the user relevancy weights outline which users are more closely related to each other based on past activity in the communication system.

The algorithm described above for computing the user relevancy weights is fully “online”, meaning that the user relevancy weights (or “relevancy graph”) can be kept up to date as each new communication event occurs, without performing any recomputation on already processed communication events. The user relevancy weights can be stored at the user terminal 102, e.g. in the memory 226, and can be retrieved by the client implemented at the user terminal 102 when the user relevancy information is needed.

As well as the user relevancy weights described above, the method of preferred embodiments also includes computing keyword relevancy weights (or scores). A keyword relevancy weight is determined for each keyword-user pair. That is, for each of a set of keywords (or “topics”) a likelihood is determined for each contact, indicating the likelihood of that contact being a participant of a communication event, given that the keyword is present in the communication event (e.g. in the subject field of an email message or in the body of an email message or instant message). For example, if the user 104 inputs a particular keyword into a communication event (e.g. into the subject field of an email message), the keyword relevancy weight for the keyword-user pair relating to the particular keyword and the user 110 would provide an indication as to the likelihood that user 110 should be a participant of the communication event. The keyword relevancy weights are based on previous communication events. The previous communication events may include, for example, email messages stored in an inbox of the user 104 or an instant messaging chat history of the user 104.

The relevancy of keywords with respect to users of the communication system 100 can be computed using text mining algorithms, such as a term frequency—inverse document frequency (TF-IDF) algorithm, Latent Dirichlet Allocation, Latent Semantic Indexing or another similar technology. The keywords that are fed to these algorithms may be identified in a text input from the user 104 for the subject field of an email message or the body of an email message or an instant messaging chat. Where the communication event is a call, the keywords may be identified using voice recognition of a voice input received from the user 104. The aforementioned algorithms can be used in an “online” manner, meaning that the keyword relevancy graph can be constantly kept up to date as new messages arrive.

As a result, each keyword can be assigned a list of contacts that are most closely related to that keyword, based on communication history. In other words, a list of weighted keyword-user pairs can be obtained. Thus, for each keyword the client at the user terminal 102 can determine, which are the users most likely to be related to that keyword/topic.

Similarly to as described above in relation to the user relevancy weights, the keyword relevancy weights decay over time. In order to achieve this, a reduction is applied to the keyword relevancy weights over time. For example, the reduction may be applied by subtracting a value from the keyword relevancy weights or by dividing the keyword relevancy weights by a factor greater than one (or by multiplying the keyword relevancy weights by a factor less than one). In this way, old connections between keywords and users of the communication system become less relevant compared to newer connections.

The keyword relevancy weights provide an indication as to the content of previous communications in the sense of which users are likely to be involved in communication events which include particular keywords. In other words, the keyword relevancy weights outline which users are more closely related to particular keywords based on past activity in the communication system.

As with the user relevancy weights, the keyword relevancy weights can be computed in an “online” manner, meaning that the keyword relevancy weights (or keyword “relevancy graph”) can be constantly kept up to date as each new communication event occurs, without performing any recomputation on already processed communication events. The keyword relevancy weights can be stored at the user terminal 102, e.g. in the memory 226, and can be retrieved by the client implemented at the user terminal 102 when the keyword relevancy information is needed.

After the relevancy information has been computed by the client at the user terminal 102 as described above, the relevancy information can be used to recommend users to be participants in a communication event.

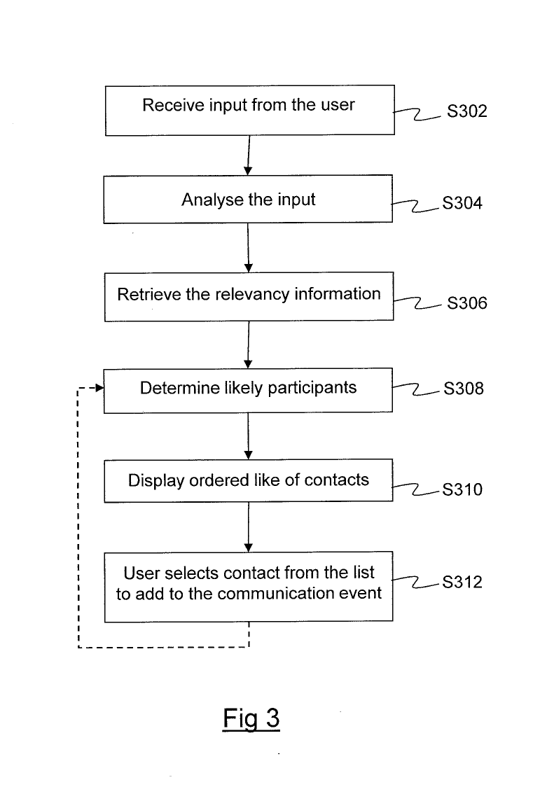

With reference to the flow chart shown in FIG. 3 there is now described a method of processing data relating to a communication event. In step S302 an input of a communication event is received by the client at the user terminal 102 from the user 104. The input may indicate a participant of the communication event or may be some information, such as text, to be included in the communication event.

In step S304 the client at the user terminal 102 analyses the input received from the user 104. This analysis is performed to determine attributes of the input. For example, the analysis may determine that the input indicates a particular participant (e.g. user 110) for the communication event. As another example, the analysis may determine that the input includes some text or voice data including a particular keyword which is to be included in the communication event (e.g. in the subject field of an email message or in the body of an email message or instant message or to be transmitted as part of a call).

In step S306 the relevancy information is retrieved by the client at the user terminal 102. For example, the relevancy information may be retrieved from the memory 226 of the user terminal 102. As described above, the relevancy information may include user relevancy weights and keyword relevancy weights computed as described above.

In step S308 the client at the user terminal 102 uses the retrieved relevancy information and the input from the user 104 to determine likely participants of the communication event. For example, if the user input indicates that the user 110 is a participant of the communication event and if there are many previous communication events in which the users 104, 110 and 114 are all participants (such that the user relevancy weight for the pair of users 110 and 114 is high) then the client will determine that the user 114 is a likely participant of the communication event. Similarly, as another example, if the user input includes a particular keyword for inclusion in the communication event and if there are many previous communication events in which that particular keyword is included and in which users 104 and 110 are participants (such that the keyword relevancy weight for the particular keyword and the user 110 is high) then the client will determine that the user 110 is a likely participant of the communication event.

In step S310 the users, who are determined to be likely participants of the communication event in step S308, are indicated to the user 104 in the user interface of the client at the user terminal 102. For example, indications of the users in the communication system 100 are displayed to the user 104 in an ordered list, which is ordered according to the likelihood that the users are to be included in the communication event. The list may include only those users of the communication system 100 who are contacts of the user 104 in the communication system. Alternatively, the list may include other users of the communication system 100 who are not contacts of the user 104 in the communication system. The client may only display those users in the list whose likelihood of being included in the communication event is above some threshold.

In step S312 the user 104 selects one or more of the likely participants from the list displayed in step S310, for example by clicking on the user's name in the list displayed in the user interface of the client at the user terminal 102. The selected users are then included as participants in the communication event.

The method shown in FIG. 3 may be “circular” in the sense that following step S312 in which the user 104 has selected a participant for the communication event, the method may pass back to step S308 (as shown by the dotted line in FIG. 3) and the method steps S308, 5310 and S312 may be repeated. In this way, as the user 104 selects more contacts to include as participants in the communication event, a new and better (e.g. more accurate) recommendation as to likely participants can be made because there is more information to base the recommendation on). In one example the user 104 has two groups of contacts he often shares a communication event with: group 1 includes contacts A, B and C, and group 2 includes contacts A, D and F. Then when initiating a new communication event, the user 104 selects user A to be a participant, and the method described above results in the recommendation of contacts B, C, D and F as likely participants since all of these contacts are in groups which also include contact A who is a participant of the communication event. In this example, if the user 104 then selects contact B to be a participant of the communication event, then the only recommended participant will become contact C, since contacts D and F have not shared a communication event with contact B.

The communication event may proceed between the participants of the communication event over the communication system using the clients implemented at respective user terminals of the participants.

The method may be implemented when the user 104 is initiating the communication event with one or more users over the communication system 100. The method may also be implemented when a communication event has already been established involving the user 104 and the user 104 wishes to add further participants to the communication event.

Therefore in the method described above in relation to the flow chart of FIG. 3, the client implemented at the user terminal 102 observes the data that the user 104 has already entered in order to bootstrap the recommendation process. The bootstrapping can be made based on already added participants, or a conversation topic or message subject of the communication event.

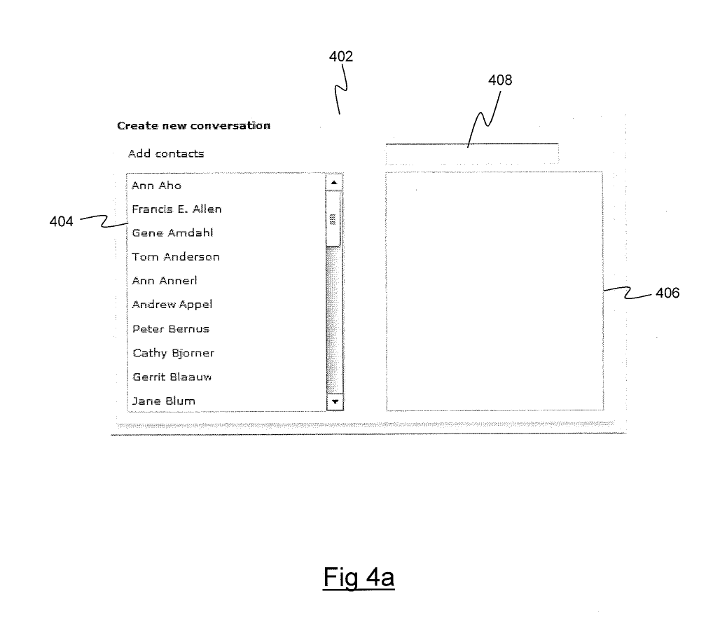

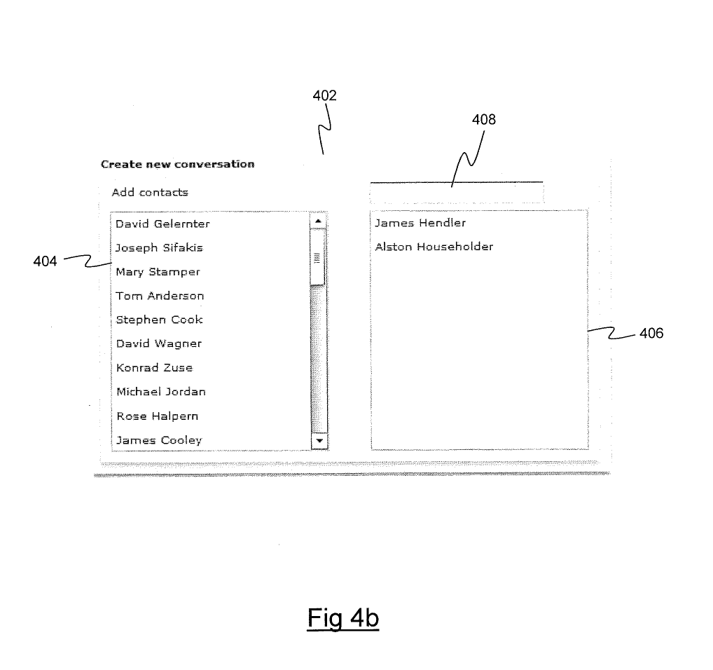

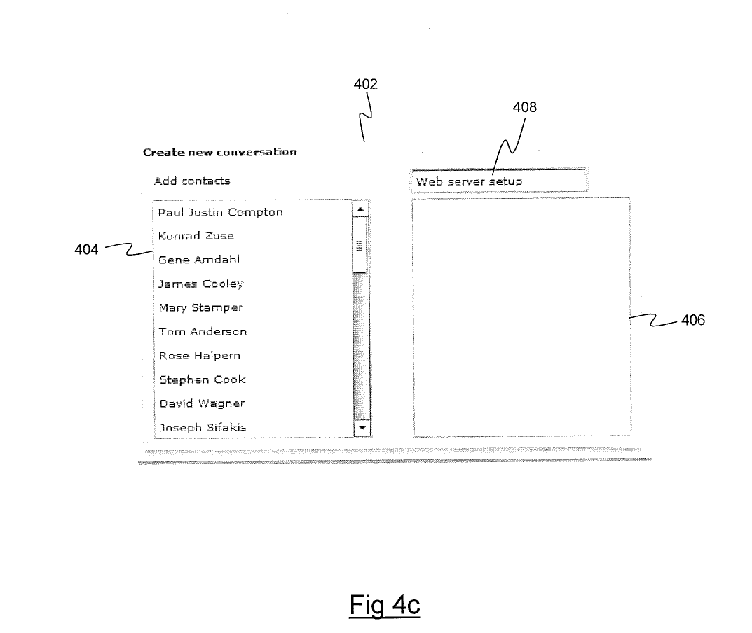

FIGS. 4a to 4c represent a user interface of the client implemented at the user terminal 102 according to various scenarios.

FIG. 4a shows a communication event initiation window 402 displayed at the user terminal 102. The window 402 comprises a contact list 404 in which contacts of the user 104 are listed alphabetically (according to surname). The window 402 also comprises a pane 406 which is used to display the current participants of the communication event which is being initiated. Initially there are no participants of the communication event which is indicated by the pane 406 including no contacts in FIG. 4a. The window 402 also comprises box 408 which is used for the user 104 to enter a subject field for the communication event.

Once the user 104 has added at least one contact to the communication event (e.g. by clicking on a contact's name in the contact list 404), a better order of the contacts in the contact list 404 can be proposed by the client, such that displayed first in the contact list 404 are those contacts which are most likely to belong to the same group as the already selected contacts, that is, those contacts which are most likely to be participants of the communication event. FIG. 4b shows the communication event initiation window 402 after the user 104 has selected two contacts to be participants of the communication event. It can be seen that the two contacts (James Hendler and Alston Householder) are participants of the communication event because their names are displayed in the pane 406. The remaining contacts have been reordered in the contact list 404, based on the already determined participants of the communication event. The contacts are reordered in the contact list 404 in an order according to the likelihood of the contacts being included as participants of the communication event based on the fact that James Hendler and Alston Householder are already participants of the communication event. The reordering is performed using the methods described above.

In another example, the user 104 may enter a message or may enter a conversation title into the box 408 as shown in FIG. 4c, in which the user 104 has entered the title “Web server setup” into the box 408. In response to the user 104 entering the text into the box 408, a better order of the contacts in the contact list 404 can be proposed by the client, such that displayed first in the contact list 404 are those contacts which are most likely to be participants of the communication event based on the text entered into the box 408. The contacts have been reordered in the contact list 404, based on the text in the box 408. The contacts are reordered in the contact list 404 in an order according to the likelihood of the contacts being included as participants of the communication event based on the title given in box 408, in other words, based on the topic of the communication event. The reordering is performed using the methods described above.

If the user 104 wishes, he/she can revert back to the default (alphabetically sorted) order for the contacts in the contact list 404.

According to embodiments described herein, contact related activities, such as creating new messages or instant messaging chats, or adding new participants to a chat, is context sensitive in the sense that both the structure and content of previous communication events are taken into account.

All the computations described herein may take place locally at the user terminal 102, and may be implemented by the client executed at the user terminal 102. In this way, the methods described herein can be implemented using a standalone user terminal 102, without any required interaction over the network 106 or with a server of the communication system. This advantageously means that there are no privacy or security concerns regarding analysis of the communication events to generate the relevancy information as described above.

Alternatively, some or all of the method steps could be implemented at a server of the communication system 100, whereby data is transmitted between the server and the client implemented at the user terminal 102 over the network 106 to allow the server to interact with the user 104 Implementing the method centrally on a server would allow previous communication events in which the user 104 was not a participant to be included in the analysis of the previous communication events, such that the relevancy information (e.g. user relevancy weights and keyword relevancy weights) may be more accurate, or may at least be computed based on a larger data set increasing the probability of achieving more accurate relevancy information.

In the embodiments described above relevancy information is used to determine the occurrence of attributes in previous communication events. As described above, this is particularly advantageous since it means that no recomputation is required of previous communication events when the likely participants for a communication event are required to be determined, since the information has already been computed and stored at the user terminal 102 in the form of the relevancy information. However, in alternative embodiments, the relevancy information is not used and instead each time the likely participants are required to be determined the client may analyse the previous communication events to determine the likely participants based on whether the previous communication events have attributes (e.g. participants and/or keywords) corresponding to those inputted by the user 104 for the current communication event.

In the methods described above a “keyword” is found in the user input. In other embodiments a phrase (i.e. a sequence of more than one word) could be found in the user input and used to compute relevancy information in the same way that a keyword is used to compute relevancy information as described above. This allows whole phrases, not just single words, to be used to determine likely participants of a communication event.

Furthermore, while this invention has been particularly shown and described with reference to preferred embodiments, it will be understood to those skilled in the art that various changes in form and detail may be made without departing from the scope of the invention as defined by the appendant claims.

What is claimed is:

1. A method of processing data relating to a communication event at a communication client, said communication event occurring over a communication system, the method comprising:
receiving, at the communication client from a user of the communication system, an input of the communication event;
analyzing the input to determine attributes of the input;
determining at least one other user of the communication system who is likely to be a participant of the communication event based on the occurrence of attributes, corresponding to the determined attributes of the input, in previous communication events over the communication system involving at least one of said at least one other user; and
the communication client indicating, to said user, said determined at least one other user as being a likely participant for the communication event.

2. The method of claim 1 wherein the user selects a user from the indicated at least one other user, and wherein the method further comprises adding the selected user as a participant of the communication event.

3. The method of claim 2 wherein said indicating comprises displaying said at least one other user in a list which is ordered according to the likelihood of the at least one other user being a participant of the communication event.

4. The method of claim 3 wherein the user selects a user from the list to include as a participant of the communication event.

5. The method of claim 1 wherein said attributes comprise an indication of a participant of the communication event.

6. The method of claim 1 wherein said attributes comprise information to be communicated in the communication event to participants of the communication event.

7. The method of claim 6 wherein the information a keyword.

8. The method of claim 7 wherein the communication event includes transmitting a message over the communication system and wherein the keyword is included in a subject field or a body of the message.

9. The method of claim 1 further comprising generating relevancy information for said at least one other user from said previous communication events, the relevancy information providing indications as to the relevancy of said at least one other user to said attributes in the previous communication events, wherein the relevancy information is used in said step of determining at least one other user of the communication system who is likely to be a participant of the communication event.

10. The method of claim 9 further comprising updating and storing the relevancy information for each communication event involving the user.

11. The method of claim 9 wherein the relevancy information comprises a respective user relevancy weight for each user-user pair in the communication system, wherein each user relevancy weight indicates the likelihood that a communication event has both of the users of the respective user-user pair as participants, given that one of the users of the respective user-user pair is a participant.

12. The method of claim 11 wherein the user relevancy weights are determined based on the participants of previous communication events for which said user is a participant.

13. The method of claim 11 further comprising, for each communication event for which said user and the users of a particular user-user pair are participants, increasing the respective user relevancy weight for the particular user-user pair.

14. The method of claim 11 further comprising applying a reduction to the user relevancy weights over time.

15. The method of claim 9 wherein the relevancy information comprises a respective keyword relevancy weight for each keyword-user pair, wherein each keyword relevancy weight indicates the likelihood that a communication event has the user of the respective keyword-user pair as a participant, given that the communication event includes the keyword of the respective keyword-user pair.

16. The method of claim 15 wherein the keyword relevancy weights are determined based on the participants of previous communication events for which said user is a participant and on the occurrence of the keywords in those previous communication events.

17. The method of claim 15 further comprising, for each communication event for which said user and the user of a particular keyword-user pair are participants and for which the communication event includes the keyword of the particular keyword-user pair, increasing the respective keyword relevancy weight for the particular keyword-user pair.

18. The method of claim 15 further comprising applying a reduction to the keyword relevancy weights over time.

19. The method of claim 1 wherein the communication event comprises one of: (i) sending an email, (ii) a call, and (iii) an instant messaging session.

20. The method of claim 1 wherein a participant of the communication event is either: (i) a recipient of the communication event, wherein the communication event is initiated by the user; or (ii) a participant of a group communication event in which the user is a participant.

21. The method of claim 1 wherein the input is for initiating the communication event.

22. The method of claim 1 wherein the input is for adding a participant to an already established communication event.

23. The method of claim 1 wherein the method is performed by the communication client at a user terminal of the user.

24. A user terminal configured to execute a communication client for processing data relating to a communication event occurring over a communication system, the communication client being configured to:
receive, from a user of the communication system, an input of the communication event;
analyze the input to determine attributes of the input;
determine at least one other user of the communication system who is likely to be a participant of the communication event based on the occurrence of attributes, corresponding to the determined attributes of the input, in previous communication events over the communication system involving at least one of said at least one other user; and
indicate, to said user, said determined at least one other user as being a likely participant for the communication event.

25. A computer program product for implementing a communication client to process data relating to a communication event, the computer program product being embodied on a non-transient computer-readable medium and configured so as when executed on a processor of a user terminal to perform the steps of claim 1.
